(19) United States
(12) Patent Application Publication
(10) Pub. No.: US 2014/0137903 A1
(43) Pub. Date: May 22, 2014

(54) DUST REMOVING DEVICE

(71) Applicant: HON HAI PRECISION INDUSTRY CO., LTD., New Taipei (TW)

(72) Inventors: MI-CHIEN CHEN, New Taipei (TW); YU-LIANG CHUANG, New Taipei (TW)

(73) Assignee: HON HAI PRECISION INDUSTRY CO., LTD., New Taipei (TW)

(21) Appl. No.: 14/071,759

(22) Filed: Nov. 5, 2013

(30) Foreign Application Priority Data
Nov. 16, 2012 (TW) 101142749

(51) Int. Cl. B08B 3/04

(52) U.S. Cl. CPC B08B 3/04
USPC 134/109

(57) ABSTRACT

A dust removing device includes a dust-proof chamber, a spraying mechanism, and a recycling mechanism. A dust-proof chamber defines the work space. A spraying mechanism includes a plurality of spraying nozzles mounted on the dust-proof chamber for spraying water into the dust-proof chamber. A recycling mechanism is placed under the dust-proof chamber, and communicates with the dust-proof chamber for recycling the water which contains the dust removed, and avoiding the build-up of dust in air extraction pipes.

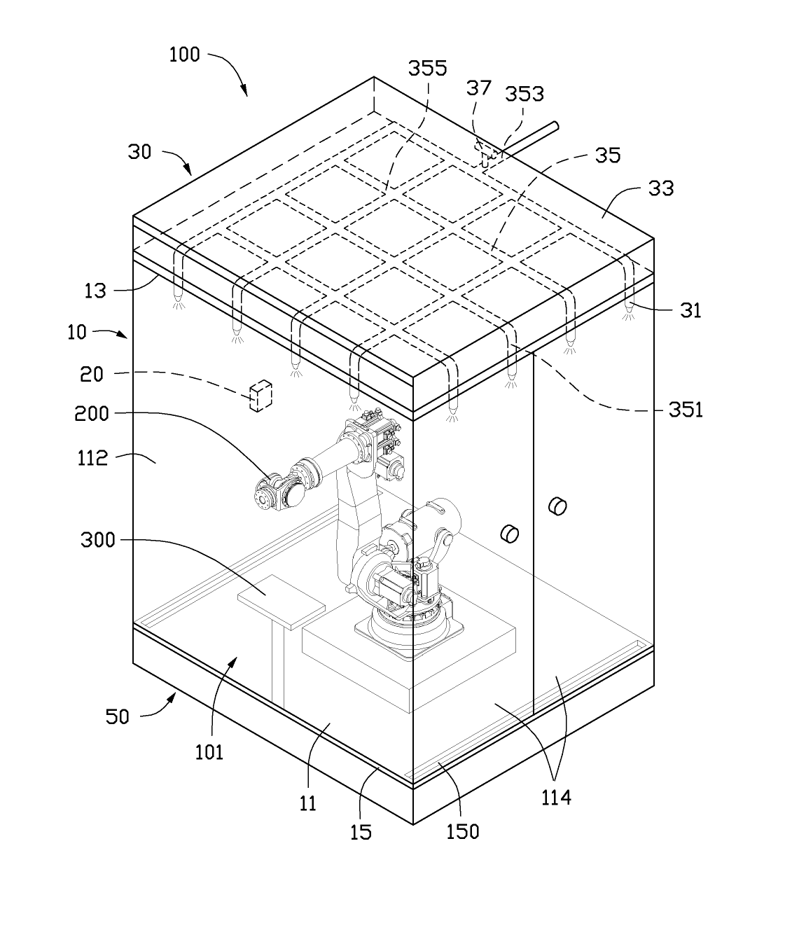

### BACKGROUND

1. Technical Field

The present disclosure relates to cleaning devices, and particularly to an industrial dust-removal device.

2. Description of the Related Art

During manufacturing, many processes generate dust, such as a polishing process. The dust pollutes the working environment, and if the dust concentration in the air is too high, a dust explosion can occur. Common dust removing device extracts the dusty air from the work space to another space to remove the dust. However, the extracting pipelines can clog easily, so the pipelines need frequent cleaning

Therefore, there is room for improvement within the art.

### BRIEF DESCRIPTION OF THE DRAWING

The components in the drawing are not necessarily drawn to scale, the emphasis instead being placed upon clearly illustrating the principles of the present disclosure.

The FIGURE is an isometric, assembled view of one embodiment of a dust-removing device.

### DETAILED DESCRIPTION

The FIGURE shows an embodiment of a dust removing device 100, which removes dust from the air in a work space. For purposes of conveniently describing the dust removing device 100, an embodiment of the dust removing device 100 as used in a polishing process is described and illustrated. In the polishing workstation, a workpiece (not shown) placed on a platform 300 is polished by a polishing robot 200. The dust removing device 100 includes a dust-proof chamber 10, a testing mechanism 20, a spraying mechanism 30, and a recycling mechanism 50. The polishing robot 200 and the platform 300 are received in the dust-proof chamber 10, such that the workpiece placed on the platform 300 can be polished by the polishing robot 200. The testing mechanism 20 is configured for testing the size of the dust particles. The spraying mechanism 30 is configured for spraying water drops into the dust-proof chamber 10. The dust is absorbed by the water. The recycling mechanism 50 is configured for recycling the waste water containing the dust.

The dust-proof chamber 10 is substantially rectangular and hollow, and includes a periphery wall 11, a top wall 13, and a bottom wall 15. The periphery wall 11, the top wall 13, and the bottom wall 15 cooperatively define a closed rectangular work space 101. The polishing robot 200 and the platform 300 are received in the work space 101. The periphery wall 11 includes a fixing portion 112 and a gate 114 movably connected to the fixing portion 112 covering an opening defined in the periphery wall 11. Polishing materials, such as consumable items and the workpieces, can be taken out or placed into the dust-proof chamber 10 via the opening. The fixing portion 112 and the gate 114 can be partly or wholly transparent, for observing the work. The bottom wall 15 defines a water channel 150 in two sides thereof.

The testing mechanism 20 is placed on the fixing portion 112 of the dust-proof chamber 10, for testing the size of the dust particles in the dust-proof chamber 10. In the illustrated embodiment, the testing mechanism 20 is placed on a middle part of the fixing portion 112. In other embodiments, the testing mechanism 20 can be placed adjacent to the top wall 13 or the bottom wall 15, or be placed at the top wall 13. A mounting position of the testing mechanism 20 (a distance from the testing mechanism 20 to the bottom wall 15) can be adjusted, according to the size of the dust particles. The greater the size of the dust particles, the smaller the distance from the testing mechanism 20 to the bottom wall 15. Thus, the testing result is more accurate.

The spraying mechanism 30 includes a plurality of spraying nozzles 31, a receiving housing 33, a supply pipeline 35, an adjustment member 37, and a water pump (not shown). The spraying nozzles 31 are mounted on the top wall 13 and evenly spaced from each other. Spraying directions of the spraying nozzles 31 are parallel or inclined to the fixing portion 112. The receiving housing 33 is placed on the top wall 13, and is substantially a rectangular box. The supply pipeline 35 is received in the receiving housing 33, and includes at least one water outlet 351, a water inlet 353, and a plurality of pipe bodies 355 connecting the at least one water outlet 351 and the water inlet 355. Each water outlet 351 is connected to one spraying nozzle 31. The water inlet 355 is connected to the water pump. The water pump is used for pressurizing water in the supply pipeline 35, so that water can be sprayed through the spraying nozzles 31. The pipe bodies 355 are interlaced and communicate with each other. The adjustment member 37 is mounted on the water inlet 335, for adjusting sizes of water drops sprayed from the spraying nozzles 31 according to the size of the dust particles established by the testing mechanism 20. In other embodiments, the spraying nozzles 31 can be placed on the fixing portion 112, such that the spraying directions are parallel to or inclined with the bottom wall 15.

The recycling mechanism 50 is a substantially rectangular box, and placed under the bottom wall 15. The recycling mechanism 50 communicates with the water channel 150 to recycle the water which has collected dust.

In use, the gate 114 is moved to overlap with the fixing portion 112, thereby revealing the opening, and allowing the polishing materials to be placed in the work space 101. When the workpieces are polished by the robot 200, the spraying mechanism 30 operates to spray water to the work space 101, such that any dust generated in the polishing process is absorbed into the water. The water containing dust flows into the recycling mechanism 50 via the water channel 150.

The spraying mechanism 30 sprays water into the work space 101, and the dust generated during the polishing process is removed by the water drops. Dust is not extracted out via an extracting pipe, and thus will not accumulate and clog the extracting pipe. In addition, the water drops with different sizes have different absorption abilities in relation to a certain size of the dust particles, and water drops with a constant size have different absorbing abilities to different sizes of dust particles. The size of the water drops can be adjusted according to the sizes of the dust particles, so that the dust can be effectively absorbed by the water drops.

The dust removing device 100 can also be used in other machining processes in which dust is generated. Accordingly, the polishing robot 200 can be other devices, such as a CNC machine. Any other liquid can also be used in the dust removing device instead of water to effectively remove dust.

It is to be understood, however, that even though numerous characteristics and advantages of the disclosure have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A dust removing device for removing dust from a work space, the dust removing device comprising:
a dust-proof chamber defining the work space;
a spraying mechanism comprising a plurality of spraying nozzles mounted on the dust-proof chamber for spraying water into the dust-proof chamber; and
a recycling mechanism placed under the dust-proof chamber, and communicating with the dust-proof chamber for recycling the water absorbed with the dust.

2. The dust removing device of claim 1, wherein the dust-proof chamber comprises a periphery wall, the periphery wall comprises a fixing portion and a gate movably connected to the fixing portion, the gate covers an opening into the dust-proof chamber.

3. The dust removing device of claim 2, wherein the dust-proof chamber further comprises a top wall connected to the periphery wall, and the plurality of spraying nozzles are placed on the top wall.

4. The dust removing device of claim 3, wherein the spraying mechanism further comprises a receiving housing and a supply pipeline, the receiving housing is placed on the top wall of the dust-proof chamber, and the supply pipeline is received in the receiving housing.

5. The dust removing device of claim 3, wherein the dust-proof chamber further comprises a bottom wall connected to the periphery wall and opposite to the top wall, the bottom wall defines a water channel, and the recycling mechanism communicates to the dust-proof chamber via the water channel.

6. The dust removing device of claim 2, wherein the plurality of spraying nozzles are placed on the periphery wall.

7. The dust removing device of claim 2, wherein the fixing portion and the gate are partly or wholly transparent.

8. The dust removing device of claim 1, further comprising a testing mechanism, wherein the testing mechanism is placed on the dust-proof chamber, for testing particle sizes of the dust in the work space.

9. The dust removing device of claim 8, wherein the spraying mechanism further comprises a supply pipeline and an adjustment member mounted on the supply pipeline, the adjustment member is capable of adjusting sizes of water drops sprayed by the plurality of spraying nozzles.

10. The dust removing device of claim 8, wherein a mounting position of the testing mechanism is adjustable according to the particle sizes of the dust in the work space.

11. A dust removing device for removing dust from a work space, the dust removing device comprising:
a dust-proof chamber defining the work space;
a spraying mechanism comprising a plurality of spraying nozzles mounted on the dust-proof chamber for spraying water into the dust-proof chamber;
a recycling mechanism placed under the dust-proof chamber, and communicating with the dust-proof chamber for recycling the water absorbed with the dust; and
a testing mechanism placed on the dust-proof chamber, for testing particle sizes of the dust in the work space, wherein the dust-proof chamber comprises a periphery wall, the periphery wall comprises a fixing portion and a gate movably connected to the fixing portion, and the gate covers an opening into the dust-proof chamber.

12. The dust removing device of claim 11, wherein the dust-proof chamber further comprises a top wall connected to the periphery wall, and the plurality of spraying nozzles are placed on the top wall.

13. The dust removing device of claim 12, wherein the spraying mechanism further comprises a receiving housing and a supply pipeline, the receiving housing is placed on the top wall of the dust-proof chamber, and the supply pipeline is received in the receiving housing.

14. The dust removing device of claim 11, wherein the dust-proof chamber further comprises a bottom wall connected to the periphery wall and opposite to the top wall, the bottom wall defines a water channel, and the recycling mechanism communicates to the dust-proof chamber via the water channel.

15. The dust removing device of claim 11, wherein the plurality of spraying nozzles are placed on the periphery wall.

16. The dust removing device of claim 11, wherein the fixing portion and the gate are partly or wholly transparent.

17. The dust removing device of claim 11, wherein the spraying mechanism further comprises a supply pipeline and an adjustment member mounted on the supply pipeline, and the adjustment member is capable of adjusting sizes of water drops sprayed by the plurality of spraying nozzles.

18. The dust removing device of claim 17, wherein a mounting position of the testing mechanism is adjustable according to the particle sizes of the dust in the work space.
